(19) United States
(12) Patent Application Publication
(10) Pub. No.: US 2025/0363409 A1
(43) Pub. Date: Nov. 27, 2025

(54) CHAIN-OF-THOUGHT MACHINE-LEARNING MODEL DEBIASING

(71) Applicant: Adobe Inc., San Jose, CA (US)

(72) Inventors: Haoliang Wang, Sunnyvale, CA (US); Xiang Chen, San Jose, CA (US); Tong Yu, Fremont, CA (US); Sungchul Kim, San Jose, CA (US); Ryan A. Rossi, San Jose, CA (US); Junda Wu, La Jolla, CA (US); Anup Bandigadi Rao, San Jose, CA (US)

(73) Assignee: Adobe Inc., San Jose, CA (US)

(21) Appl. No.: 18/673,547

(22) Filed: May 24, 2024

(51) Int. Cl. G06N 20/00

(52) U.S. Cl. CPC G06N 20/00

(57) ABSTRACT

Change-of-thought machine-learning model debiasing techniques and systems are described. A query is received and context data is produced based on the query, e.g., from an external source. A prompt is generated that includes the context data, the query, and a chain-of-though prompt, which is processed by a machine-learning model. A candidate result based on processing of the prompt using the machine-learning model. The candidate result includes a candidate answer and a chain-of-thought result describing reasoning indicated by the machine-learning model as used in generating the candidate answer.

### BACKGROUND

Functionality of machine-learning models as well as technologies that rely on machine-learning models continue to expand. However, this expansion has exhibited a corresponding increase in complexity and computational resources utilized to train the machine-learning models. An example of which is known as a large language model.

Large language models are configured to understand, generate, and even manipulate human language. To do so, the large language models are trained on a vast amount of training data to learn an internal knowledge representation of patterns, statistics, and structures learned from the vast amount of data. Because of this, large language models are dependent on accuracy of the training data, which is real world scenarios has exhibited bias and therefore inaccuracies in results generated by the large language models.

### SUMMARY

Change-of-thought machine-learning model debiasing techniques and systems are described. In one or more examples, a debiasing module leverages chain-of-thought prompting and external knowledge as an instrumental variable as context data. By changing a value of the context data (e.g., from factual to counterfactual), the debiasing module is configurable to estimate a causal effect between a chain-of-thought used by the machine-learning model to generate a result as an answer to a query. In this way, a correlation between one or more chains-of-thought used by the machine-learning model to generate the results is usable to detect the causal effect and thus potential bias in the internal knowledge representation of the machine-learning model.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ machine-learning model debiasing techniques based on chain-of-thought as described herein.

FIG. 2 depicts a system in an example implementation showing operation of a debiasing module of FIG. 2 in greater detail as determining a causal effect of context data on a result of a search performed by a machine-learning model.

FIG. 3 depicts a system in an example implementation showing operation of a prompt generation module of FIG. 2 in greater detail as generating factual and counterfactual prompts as part of bias detection.

FIG. 4 depicts a system in an example implementation showing operation of an input module input module and context production module in greater detail as receiving a query and locating context data.

FIG. 5 depicts a system in an example implementation showing operation of a prompt generation module of FIG. 3 in greater detail as generating factual and counterfactual prompts based on the query and context data of FIG. 4.

FIG. 6 depicts a system in an example implementation showing candidate results generated by the machine-learning model of FIG. 3 based on the prompts as generated in FIG. 5 that are used to estimate causal effect and detect bias in operation of the machine-learning model.

FIG. 7 is a flow diagram depicting an algorithm as a step-by-step procedure in an example implementation of operations performable for accomplishing a result of machine-learning model debiasing based on causal effect detected using chain-of-thought.

FIG. 8 depicts an example algorithm as pseudocode configured to perform debiasing based on chain-of-thought.

FIG. 9 illustrates an example system including various components of an example device that can be implemented as any type of computing device as described and/or utilize with reference to the previous figures to implement embodiments of the techniques described herein.

### DETAILED DESCRIPTION

### Overview

Machine-learning models are usable in a variety of contexts. An example of one such context involves use of specific knowledge to obtain an accurate result. To do so, the machine-learning models rely on an internal knowledge representation generated during training of the machine-learning model to gain this knowledge. However, the internal knowledge representation may be outdated over time and exhibit bias based on the training data that results in inaccuracies in generating a result.

These challenges are further exacerbated when confronted with large language models, which may contain millions and even billions of parameters. Large language models, for instance, may be trained using biased information such that a knowledge bias further causes a knowledge conflict or misunderstanding that is incorporated as part the internal knowledge representation of the large language models. The knowledge conflict or misrepresentation, for instance, may make erroneous connections between entities thereby causing inaccuracies in the results that encounter this bias. Additionally, size of the large language models makes training and fine-tuning of the computationally expensive and inefficient to perform.

Accordingly, change-of-thought machine-learning model debiasing techniques and systems are described that are configurable to detect and even mitigate an effect of bias in an internal representation of a machine-learning model, such as a large language model. To do so, a search system that employs a machine-learning model (e.g., large language model) leverages chain-of-thought prompting and external knowledge as an instrumental variable as context data through use of a debiasing module.

By changing a value of the context data (e.g., from factual to counterfactual), the debiasing module is configurable to estimate a causal effect between a chain-of-thought used by the machine-learning model to generate a result as an answer to a query. In this way, a correlation between one or more chains-of-thought used by the machine-learning model to generate the results is usable to detect the causal effect and thus potential bias in the internal knowledge representation of the machine-learning model. This detection is usable in a variety of ways, including detection of accuracy in generating the results, use to mitigate against the bias, and so forth.

Consider a scenario in which a query is received that poses a question “Ragnarök was collaborated by Ebony and the heavy metal band formed in which city?” The debiasing module obtains context data from an external knowledge source that is independent of an internal knowledge source utilized by the machine-learning model. The context data, for instance, is not obtained from the machine-learning model but rather from another source, e.g., from a search of a database that is not used to train the machine-learning model. The debiasing module, for instance, compiles context data such as “Ragnarök is by Biological Agent formed in Brooklyn” from an online search engine.

The debiasing module then generates a prompt to be input to the machine-learning model. To do so, the debiasing module includes the query, the context data, and a chain-of-thought prompt. The chain-of-thought prompt is configured to cause the machine-learning model to include data in a candidate result indicating reasoning employed by the machine-learning model in generating the candidate result, and more particularly a candidate answer in the candidate result. The candidate result, as indicating the chain-of-though used to generate the candidate answer, is therefore usable by the debiasing module to determine a causal effect of the context data in generating the search result.

In one or more examples, the debiasing module is configurable to generate factual and counterfactual prompts in order to estimate the causal effect. The debiasing module, for instance, is configurable to generate the factual prompt as including the factual context data “Ragnarök is by Biological Agent formed in Brooklyn.” The debiasing module is also configurable to generate a counterfactual prompt, e.g., by replacing an entity specified by the factual context data with a different entity.

Continuing with the previous example, the debiasing module generates a first counterfactual prompt that includes first counterfactual context data of “Ragnarök is by Biological Agent formed in Chicago.” The debiasing module also generates a second counterfactual prompt in this example that includes second counterfactual context data, e.g., “Ragnarök was by Thrash Baghdad formed in Iraq.”

The debiasing module then estimates the causal effect and thus corresponding bias by comparing a factual candidate result obtained based on the factual prompt, a first counterfactual candidate result obtained based on the first counterfactual prompt, and a second counterfactual candidate result obtained based on the second counterfactual prompt. The debiasing module, for instance, estimates an average causal effect (ACE) based on correspondence of the candidate answers with the candidate chains-of-thought.

A first set of candidate results, for instance, having a chain-of-thought result “Biological Agent is formed in Brooklyn” provides an answer of “Brooklyn” in the factual candidate result (and is correct), “Chicago” for the first counterfactual candidate result, and “Iraq” for the second counterfactual candidate result. However, a second set of candidate results having a chain-of-thought result “The heavy metal band formed in Jakarta is Eternal” provides a same corresponding answer of “Jakarta” for each of the factual candidate result, the first counterfactual candidate result, and the second counterfactual candidate result. Thus, the second set of candidate results remain unchanged due to a spurious correlation in the second chain-of-thought.

From this, the debiasing module is configurable to estimate bias and detect a source of the bias as indicated by the chain-of-thought result for the second set of candidate results. Bias detection by the debiasing module is usable in a variety of ways, including detection of accuracy in generating the results, mitigate against the bias, and so forth. For example, direct causal intervention techniques on machine-learning models have limited effectiveness. Therefore, the search system through use of the debiasing module is configurable to construct importance scores in terms of how a candidate answer in a candidate result reacts to different chains-of-thought as intervened using different context data. The importances scores are then usable to introduce as a chain-of-thought exhibiting a relatively largest average causal effect as a mediator in generating a subsequent search result. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Machine-Learning Model Debiasing Environment

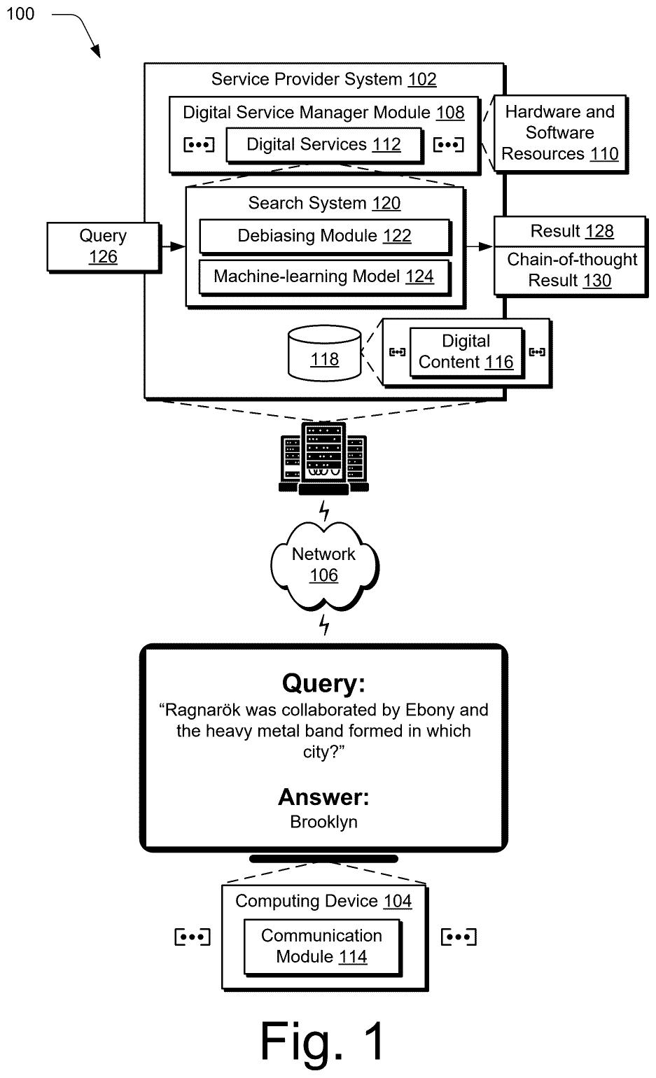

FIG. 1 is an illustration of a digital medium environment 100 in an example implementation that is operable to employ machine-learning model debiasing techniques based on chain-of-thought as described herein. The illustrated environment 100 includes a service provider system 102 and a computing device 104 that are communicatively coupled, one to another, via a network 106. Computing devices are configurable in a variety of ways.

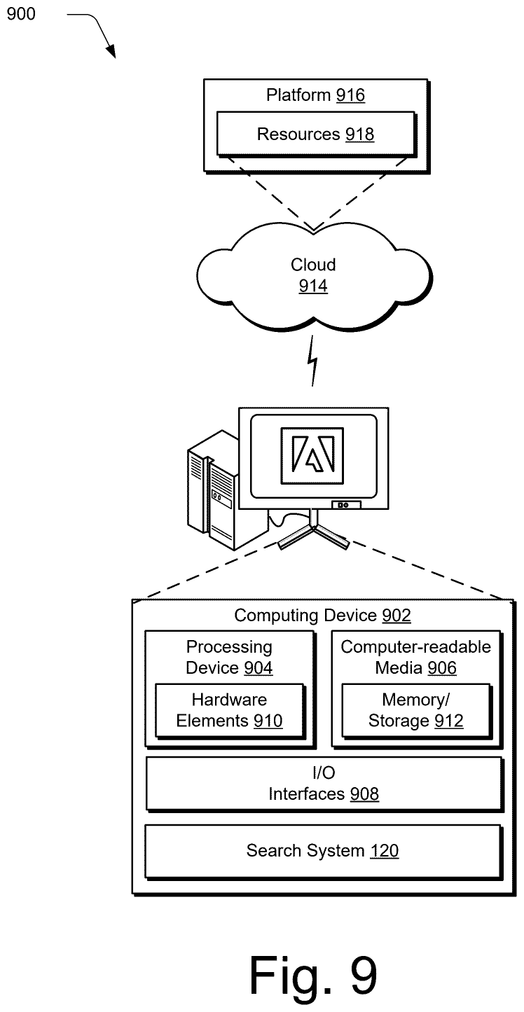

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 9.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

The service provider system 102 is also illustrated as including storage device 118, which is illustrated as maintained locally at the service provider system 102 but may also be accessible in a variety of other ways, e.g., via the network 106. The digital content 116, for instance, is configurable as an external knowledge source (e.g., using webpages, digital documents, digital audio, digital video, digital images, and so forth) that is accessible via a variety of entities, examples of which include databases, third-party systems, and so forth.

In the illustrated example, the digital services 112 are utilized to implement a search system 120. The search system 120 includes a debiasing module 122 that is configurable to detect and even mitigate against bias included as part of an internal knowledge representation maintained by a machine-learning model 124. As previously described, conventional techniques ignore biases (e.g., which may also include use of outdated information) learned by a machine-learning model 124.

Simply injecting external knowledge in the prompts, as performed in some conventional techniques utilized to address bias, does not guarantee that the machine-learning models are capable of identifying and using relevant information in the prompts, especially in instances in which the machine-learning models learn biased information as part of training. Bias (i.e., knowledge bias) in machine learning models may further cause knowledge conflicts and misunderstandings between external knowledge and internal knowledge employed by the model. In such instances, machine-learning models that employ these conventional techniques may use irrelevant information and generate incorrect and unexpected results. As a result, use of biased information impairs a reasoning ability of the machine-learning model in generating an accurate result.

Accordingly, in the techniques described herein the debiasing module 122 is configured to discover usage of irrelevant information that causes bias in processing a query 126 to generate a result 128 by the machine-learning model 124. The debiasing module 122, for instance, is configurable to introduce external knowledge as context data into prompts processed by the machine-learning model 124 as an instrumental variable. A result 128 is then generated by the machine-learning model 124 that includes a chain-of-thought result 130 indicating reasoning indicated by the machine-learning model as used in generating the result 128. By doing so, the debiasing module 122 detects a causal effect of the context data on the result 128 and thus bias of the internal knowledge representation employed by the machine-learning model 124, which is not possible in conventional techniques. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Machine-learning Debiasing based on Causal Effect

The following discussion describes debiasing techniques for a machine-learning model based on causal effect detected using chain-of-thought that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks.

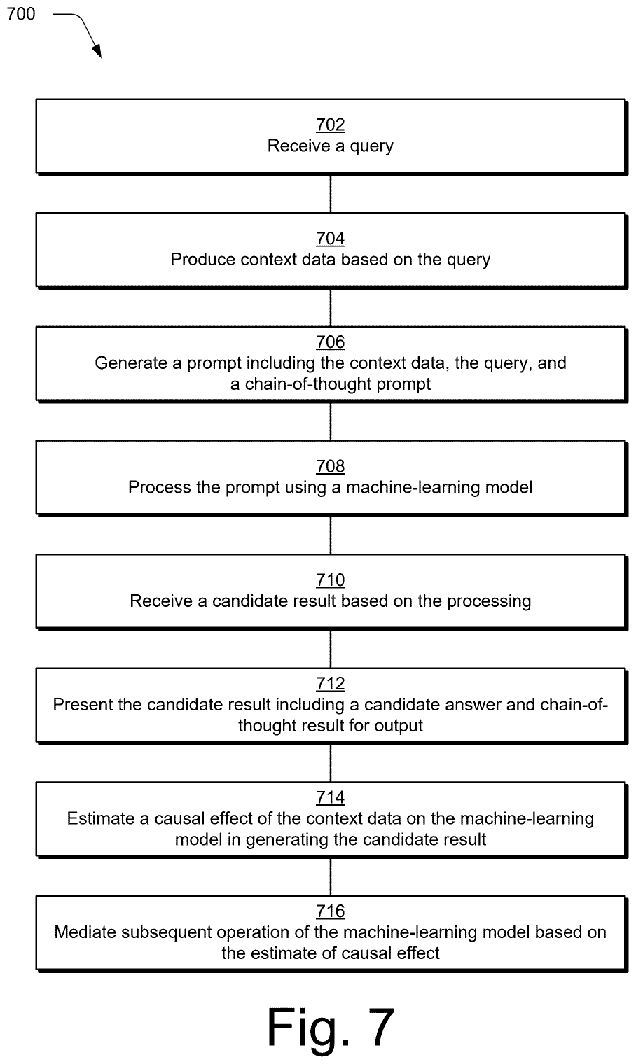

Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 7 is a flow diagram depicting an algorithm 700 as a step-by-step procedure in an example implementation of operations performable for accomplishing a result of machine-learning model debiasing based on causal effect detected using chain-of-thought. In portions of the following discussion, reference will be made in parallel with FIG. 7.

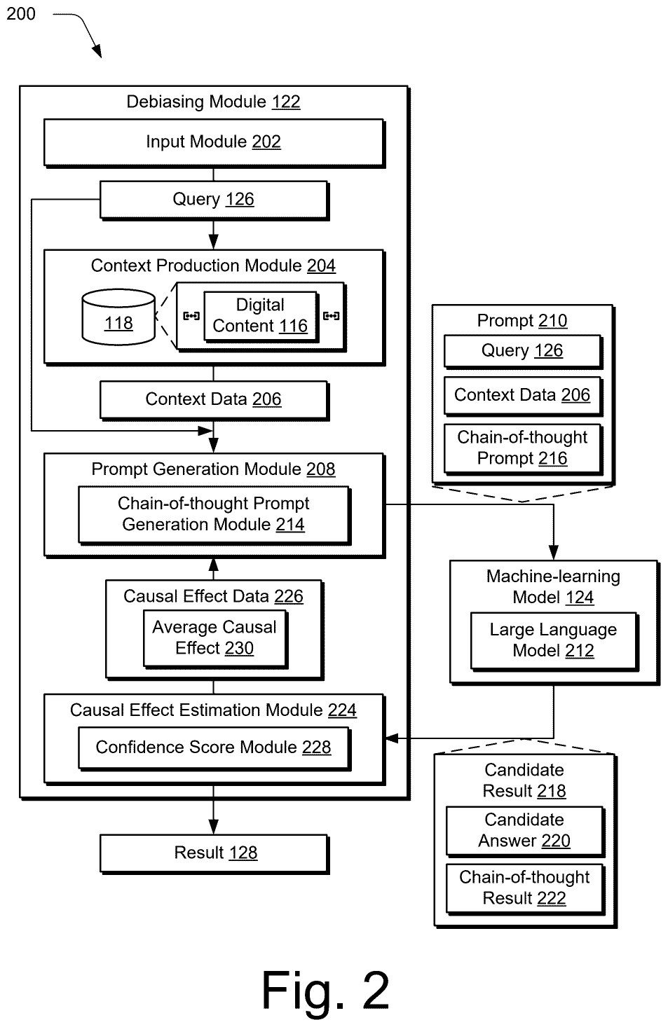

FIG. 2 depicts a system 200 in an example implementation showing operation of a debiasing module 122 of FIG. 2 in greater detail as determining a causal effect of context data on a result of a search performed by a machine-learning model. To begin in this example, an input module 202 receives a query 126 (block 702). The query 126, for instance, may be provided via a web-based interface, a mobile application, or any other client software capable of communicating with the service provider system 102 over the network 106. The communication module 114, for instance, may facilitate the transmission of the query from the computing device 104 to the service provider system 102. The input module 202 is further configurable to perform initial parsing, validation, and formatting to ensure that the query 126 is in a suitable form for further processing by the debiasing module 122.

The query 126 is then passed as an input to a context production module 204 to produce context data 206 (block 704). The context production module 204 is configurable to employ a variety of techniques to produce context data 206 as relevant to the query 126. The context production module 204, for example, access digital content 116 stored in the storage device 118 as an external knowledge source that is independent of the internal knowledge source used by the machine-learning model 124, i.e., that is used to train the machine-learning model 124. For instance, the context production module 204 is configurable to perform an online search using an online search engine or database to locate information related to the query, retrieve and compile data from digital repositories, webpages, documents, or other digital media that can provide factual information to support the query, and so forth.

The query 126 and the context data 206 are then passed as an input to a prompt generation module 208 to generate a prompt 210. The prompt 210 is formatted for input to the machine-learning model 124 by the prompt generation module 208 and includes the query 126 and the context data 206. A chain-of-thought prompt generation module 214 is further utilized to generate a chain-of-thought prompt 216 that is configured to cause the machine-learning model 124 to surface reasoning utilized in generating an answer to a question posed by the query 126. Accordingly, the prompt 210 is generated by the prompt generation module 208 to include the query 126, the context data 206, and the chain-of-thought prompt 216 (block 706).

The machine-learning model 124 (e.g., a large language model 212) then processes the prompt (block 708) to generate a candidate result 218. The candidate result 218 includes a candidate answer 220 to a question posed by the query 126. The candidate result 218 further includes a chain-of-thought result 222 that is generated by the machine-learning model 124 to describe reasoning employed by the machine-learning model 124 in generating the candidate answer 220.

The debiasing module 122 then receives the candidate result 218 based on processing of the prompt 210 by the machine-learning model 124 (block 710). In an implementation, the debiasing module 122 may then present the candidate result 218 including the candidate answer 220 and the chain-of-thought result 222 for output (block 712), e.g., for communication over the network 106 for display in a user interface, for output to another module for further processing, and so forth.

In the illustrated example of FIG. 2, a causal effect estimation module 224 is employed generate causal effect data 226 having an estimate of a causal effect of the 206 context data on the machine-learning model 124 in generating the candidate result 218 (block 714). The prompt generation module 208, for instance, is configurable to generate a plurality of prompts 210. Confidence scores are then generated by a confidence score module 228 based on a plurality of candidate results 218 to these prompts. The confidence scores are then used to calculate an average causal effect 230 (ACE), which serves as a measure of how robust each chain-of-thought is against bias by the machine-learning model 124.

The causal effect data 226 is usable to support a variety of functionality, an example of which includes to mediate subsequent operation of the machine-learning model based on the estimate of causal effect (block 716). The average causal effect 230, for instance, is usable to guide a sampling process to identify a least biased chain-of-thought. This chain is then used (e.g., as context data 206) to prompt the machine-learning model 124 once more (e.g., along with the query 126), aiming to generate a final, debiased result 128. By selecting the chain-of-thoughts with the least bias, the debiasing module 122 operates to reduce bias introduced by irrelevant information or biases in an internal knowledge representation employed by the machine-learning model 124.

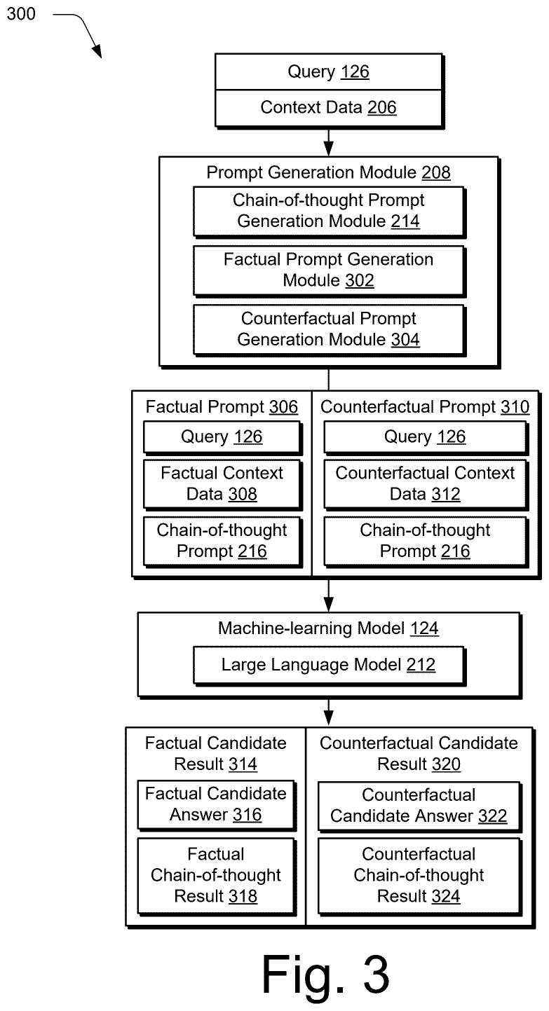

FIG. 3 depicts a system 300 in an example implementation showing operation of the prompt generation module 208 of FIG. 2 in greater detail as generating factual and counterfactual prompts as part of bias detection. The prompt generation module 208, as previously described, includes a chain-of-thought prompt generation module 214 that is configured to generate a chain-of-thought prompt 216 to cause the machine-learning model 124 to explain reasoning behind generation of a corresponding answer.

The prompt generation module 208 in the illustrated example also includes a factual prompt generation module 302 and a counterfactual prompt generation module 304. The factual prompt generation module 302 is configured to generate a factual prompt 306 having the query 126 and factual context data 308. The counterfactual prompt generation module 304, on the other hand, is configured to generate a counterfactual prompt 310 having the query 126 and counterfactual context data 312.

The factual prompt 306 is processed by the machine-learning model 124 (e.g., large language model 212) to generate a factual candidate result 314 that includes a factual candidate answer 316 and a factual chain-of-thought result 318. The counterfactual prompt 310 is also processed by the machine-learning model 124 to generate a counterfactual candidate result 320 that includes a counterfactual candidate answer 322 and a counterfactual chain-of-thought result 324. By comparing the factual candidate result 314 and the counterfactual candidate result 320, the causal effect estimation module 224 is configurable to generate the causal effect data 226 (e.g., an average causal effect 230) to detect bias in the internal knowledge representation of the machine-learning model 124.

For knowledge-intensive question-answering tasks, the machine-learning model 124 is prompted with a query 126 “Q=[q₁,q₂, . . . , qₙ]” and a passage of context data 206 “E=[e₁,e₂, . . . , eₗ],” i.e., external knowledge. Given the query 126 “Q” and the context data 206 “E,” the machine-learning model 124 “θ” is prompted to recurrently generate the candidate result 218 “Y” by sampling from a conditional probability distribution as follows:

$$yt ∼ {p}_{θ} ( y \vert E , Q , {y}_{< t} )$$

Additionally, the context production module 204 is configured to generate the chain-of-thought prompt 216 as an additional instruction to ask the machine-learning model 124 to generate chain-of-thought result 222 that describes reasoning paths “C”, step-by-step, before generating the final result 128 “A,” i.e., “Y=[C,A].” By sampling “N” different chain-of-thought results 222 “C=[C₁,C₂, . . . , C_{N}]” conditioned on the query 126 “Q” and the context data 206 “E,” the generation process of the result 128 “A” is further conditioned against bias.

$${C}_{i} ∼ {p}_{θ} ( C \vert E , Q ) , \qquad Equation ( 1 )$$

$${A}_{i , r} ∼ {p}_{θ} ( A \vert E , Q , {C}_{i} ) , \qquad Equation ( 2 )$$

In Equation (1), since the chain-of-thought result 130 “C” are also generated by the machine-learning model 124, the pretrained internal knowledge “Z” can also confound on the generation process. Therefore, this can affect factual accuracy of the generated chain-of-thought result 130 as incorrect reasoning logic as well as the result 128 “A” and as such are employed for correcting logical errors in a chain of thought as further described below.

The debiasing module 122 is configurable to employ the chain-of-thought results 222 “C=[C₁,C₂, . . . , C_{N}]” as a mediator between the query 126 “Q” and the result 128 “A.” The mediator, in order to support accurate operation, is causally independent of an internal knowledge representation “Z” of the machine-learning model 124 to enable front-door adjustment. In practice, however, the chain-of-thought result 222 are also generated by the machine-learning model 124, which has a potential for spurious correlations between the chain-of-thought result 130 and an internal knowledge representation “Z” of the machine-learning model 124.

Accordingly, to detect bias from an unobserved internal knowledge representation “Z” of the machine-learning model 124, the context data 206 is produced as an instrumental variable (IV) from external knowledge independent of the internal knowledge representation. By changing the context data 206, and thus the instrumental variable, the debiasing module 122 is configured to estimate a true causal relationship between the chain-of-thought result 222 “C” and the candidate answer 220 “A.”

Due to the limitation of directly controlling the generation process of chains-of-thought, causal treatment is performed by including counterfactual knowledge through the instrumental variable “E.” Specifically, a machine-learning model is employed to extract “T” factual entities “V=[v₁,v₂, . . . , V_{T}]” which correspond to “T” counterfactual context “E₁*, E₂*, . . . , E_{T}*.” In each sample:

$${E}_{j}^{*} = [ {e}_{1} , {e}_{2} , … , {v}_{j} , … , {e}_{1} ]$$

the corresponding factual entity “vⱼ” is to be replaced by counterfactual entities. Then, the machine-learning model is further prompted to propose “P” counterfactual entities:

$${V}_{j}^{*} = [ {V}_{j , 1}^{*} , {V}_{j , 2}^{*} , … , {V}_{j , p}^{*} ]$$

To each extracted entity “vⱼ∈V” which are used to produce “P” counterfactual context samples:

$${E}_{j , k}^{*} ( {V}_{j , k}^{*} ) = [ {e}_{1} , {e}_{2} , … , {v}_{j , k}^{*} , … , {e}_{1} ] , k \leq P , \qquad Equation ( 3 )$$

are constructed by replacing the corresponding factual entity “vⱼ” in each sample “Eⱼ*.” In this approach, the average causal effect is estimated corresponding to each chain-of-though result (i.e., chain-of-though reasoning path) “Cᵢ” by:

$$\begin{matrix}ACE ( {C}_{i} , {v}_{j} ) = 𝔼 ( A \vert do ( E ) , Q , {C}_{i} ) - \\ 𝔼 ( A \vert do ( {E}_{j}^{*} ) , Q , {C}_{i} ) \\ = {𝔼}_{{v}_{j , k}^{*} ∈ {V}_{j}^{*}} [ {p}_{θ} ( A \vert F , Q , {C}_{i} ) - \\ {p}_{θ} ( A \vert {E}_{j , k}^{*} ( {v}_{j , k}^{*} ) , Q , {C}_{i} ) ]\end{matrix} , \qquad Equation ( 4 )$$

in which the average causal effect measures the decreased confidence in the answer (measured in Equation 2) with counterfactual context as the evidence. Average causal effect of different factual entities is variable based on context, queries, and chains-of-thought. To consider the overall causal effect of the external context on each chain-of-thought, the average cause effect is measurable for each of the intervened entities:

$$ACE ( {C}_{i} ) = {𝔼}_{{v}_{i} ∈ V} ACE ( {C}_{i} , {v}_{j} ) , \qquad Equation ( 5 )$$

where the intervened entities “vⱼ” are sampled from a uniform distribution of external context “E,” e.g., by the context production module 204 from the digital content 116.

A sampling approach is then employed in this example to obtain high quality chains-of-thought having increased reasoning coherency. Because machine-learning models 124, and particularly large language models, are “black-box models” providing limited insight, effectiveness of direct causal intervention techniques on parametrization of an input query and context are limited. Accordingly, sampled chains-of-thought are employable by the causal effect estimation module 224 as a mediator variable to conduct a “front door” adjustment to a prompt.

For example, importance scores are constructed by the causal effect estimation module 224 based on the measured average causal effect in terms of how a final answer “A” reacts to different chains-of-thought “C” intervened by a context “E” as follows:

$${C}^{*} ∼ softmax [ {p}_{θ} ( {C}_{i} \vert E , Q ) \cdot ACE ( {C}_{i} ) ] , \qquad Equation ( 6 )$$

and the front-door adjustment is realized by introducing the mediator “C*” sampled based on a largest average cause effect in the reasoning path (i.e., chain-of-thought):

$${A}^{*} ∼ P ( A \vert E , Q , do ( C ) ) ∝ {p}_{θ} ( A \vert E , Q , {C}^{*} ) , \qquad Equation ( 7 )$$

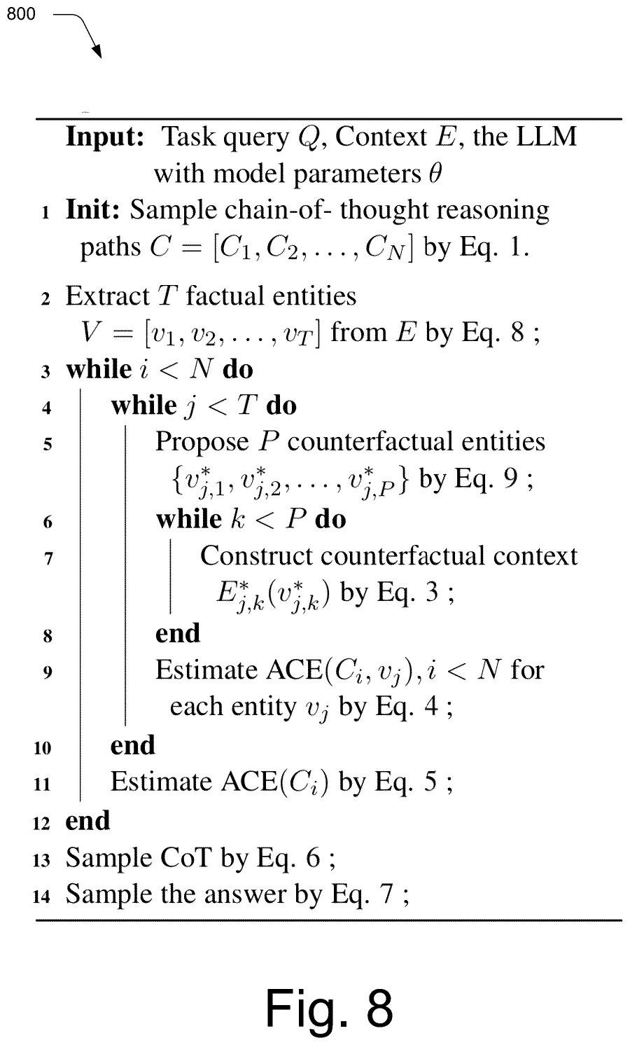

The causal effect on the sampled result “A*” (i.e., answer) is mediated by the sampled chain-of-thought reasoning path “C*” whose mediator-outcome confounding effect is controlled and alleviated. FIG. 8 depicts an example algorithm 800 as pseudocode configured to perform debiasing based on chain-of-thought.

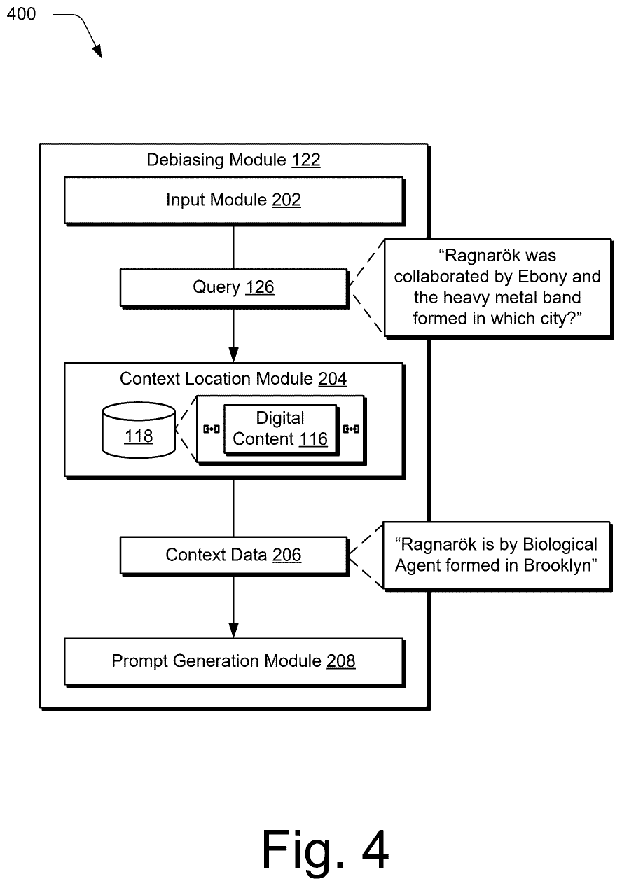

FIG. 4 depicts a system 400 in an example implementation showing operation of an input module input module 202 and context production module 204 in greater detail as receiving a query and locating context data. In this example, the input module input module 202 receives a query 126. The query 126 includes the text “Ragnarök was collaborated by Ebony and the heavy metal band formed in which city?”

Based on the query 126, the context production module 204 generates context data 206 as an injection from external knowledge. The context production module 204, for instance, is configured to perform an online search based on one or more entities named in the query 126 to generate context data 206 as “Ragnarök is by Biological Agent formed in Brooklyn.” The query 126 and the context data 206 are then passed to a prompt generation module 208 for prompt generation.

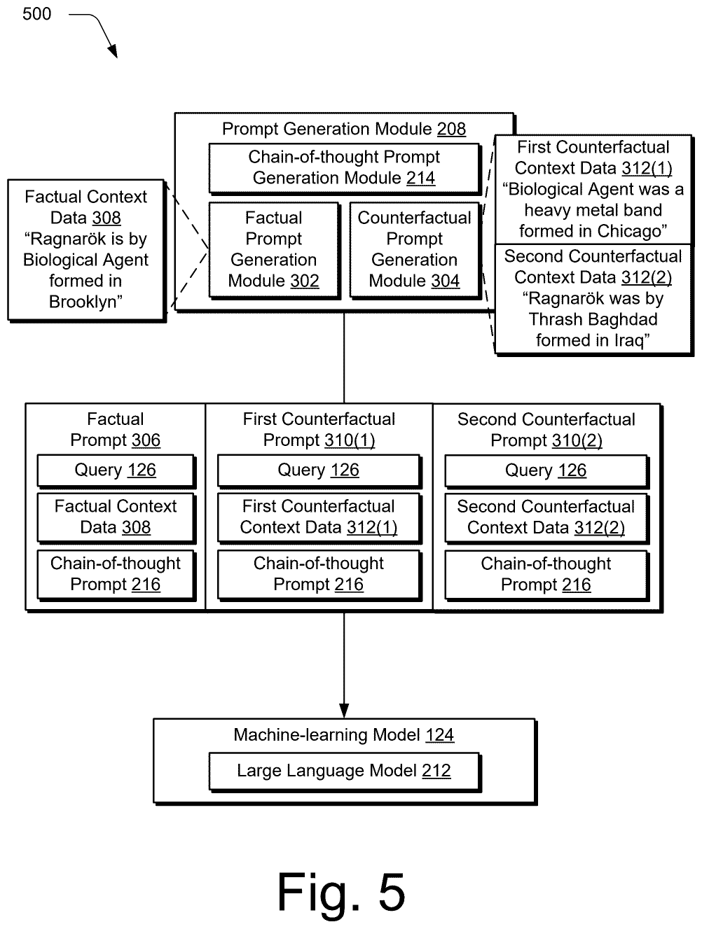

FIG. 5 depicts a system 500 in an example implementation showing operation of the prompt generation module 208 of FIG. 3 in greater detail as generating factual and counterfactual prompts based on the query and context data of FIG. 4. In this example, the factual prompt generation module 302 generates the factual prompt 306 to include factual context data 308 based on the context data 206 produced by the context production module 204. The factual prompt 306 therefore includes the query 126 “Ragnarök was collaborated by Ebony and the heavy metal band formed in which city?” and the factual context data 308 of “Ragnarök is by Biological Agent formed in Brooklyn.” The factual prompt 306 also includes a chain-of-thought prompt 216 to cause the machine-learning model 124 to “explain its reasoning” as previously described.

The counterfactual prompt generation module 304 is configured to generate counterfactual context data 312. The counterfactual prompt generation module 304, for instance, generates first counterfactual context data 312(1) as “Biological Agent was a heavy metal band formed in Chicago.” The counterfactual prompt generation module 304 also generates second counterfactual context data 312(2) as “Ragnarök was by Thrash Baghdad formed in Iraq.”

Therefore, a first counterfactual prompt 310(1) is generated by the counterfactual prompt generation module 304 that includes the query 126, the first counterfactual context data 312(1), and the chain-of-thought prompt 216. A second counterfactual prompt 310(2) is also generated by the counterfactual prompt generation module 304 that includes the query 126, the second counterfactual context data 312(2), and the chain-of-thought prompt 216. The factual prompt 306, the first counterfactual prompt 310(1), and the second counterfactual prompt 310(2) are then passed as inputs for processing by the machine-learning model 124.

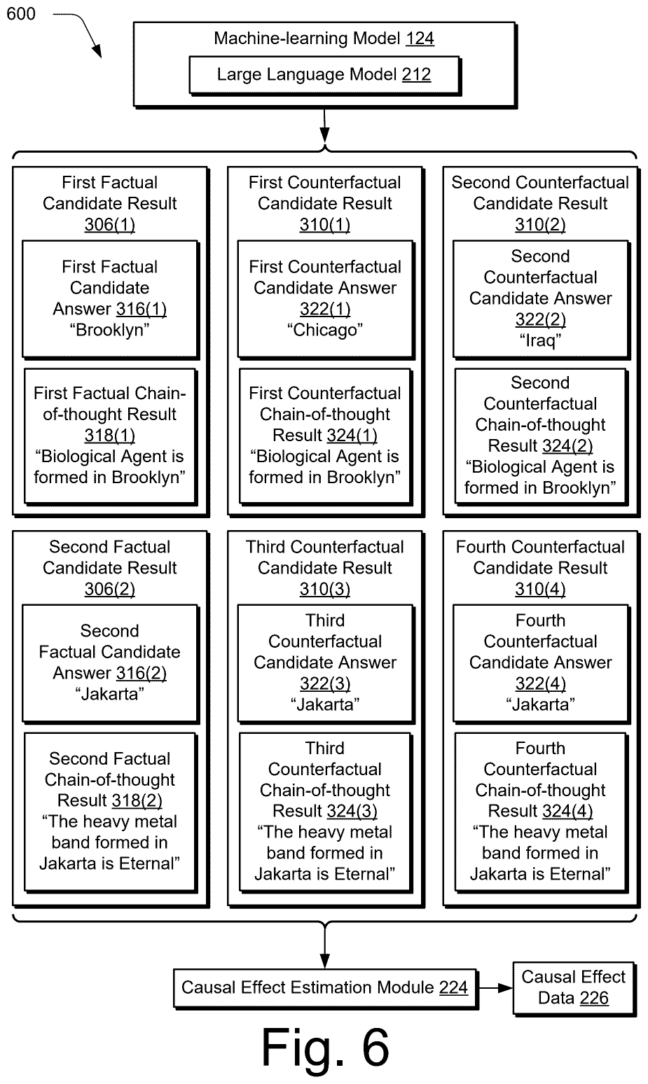

FIG. 6 depicts a system 600 in an example implementation showing candidate results generated by the machine-learning model 124 of FIG. 3 based on the prompts as generated in FIG. 5 that are used to estimate causal effect and detect bias in operation of the machine-learning model 124. The candidate results include first and second sets corresponding to first and second instances of respective chains-of-thought.

A first set of results includes a first factual candidate result 306(1), a first counterfactual candidate result 310(1), and a second counterfactual candidate result 310(2) as processed based on the factual prompt 306, the first counterfactual prompt 310(1), and the second counterfactual prompt 310(2). The first factual candidate result 306(1) includes a first factual candidate answer 316(1) of “Brooklyn” and a first factual chain-of-thought result 318(1) of “Biological Agent is formed in Brooklyn.” The first counterfactual candidate result 310(1) includes a first counterfactual candidate answer 322(1) of “Chicago” and a first counterfactual chain-of-thought result 324(1) of “Biological Agent is formed in Brooklyn.” The second counterfactual candidate result 310(2) includes a second counterfactual candidate answer 322(2) of “Iraq” and a second counterfactual chain-of-thought result 324(1) of “Biological Agent is formed in Brooklyn.”

A second set of results includes a second factual candidate result 306(2), a third counterfactual candidate result 310(3), and a fourth counterfactual candidate result 310(4) as also processed based on the factual prompt 306, the first counterfactual prompt 310(1), and the second counterfactual prompt 310(2). The second factual candidate result 306(2) includes a second factual candidate answer 316(2) of “Jakarta” and a second factual chain-of-thought result 318(2) of “The heavy metal band formed in Jakarta is Eternal.”

The third counterfactual candidate result 310(3) includes a third counterfactual candidate answer 322(3) of “Jakarta” and a third counterfactual chain-of-thought result 324(3) of “The heavy metal band formed in Jakarta is Eternal.” The fourth counterfactual candidate result 310(4) includes a fourth counterfactual candidate answer 322(4) of “Jakarta” and a fourth counterfactual chain-of-thought result 324(1) of “The heavy metal band formed in Jakarta is Eternal.”

Thus, in this example two pieces of counterfactual external knowledge are introduced as first counterfactual context data 312(1) “Biological Agent was a heavy metal band formed in Chicago” and Second Counterfactual Context Data 312(2) “Ragnarök was by Thrash Baghdad formed in Iraq.” Causal effect data 226 is generated as an average causal effect by the causal effect estimation module 224. Due to the spurious correlation of the chain-of-thought results of “Biological Agent was a heavy metal band formed in Chicago,” results (i.e., answers) generated based on this chain-of-thought remain unchanged for the first set, e.g., the first factual candidate result 306(1), the first counterfactual candidate results 310(1), and the second counterfactual candidate result 310(2). However, results generated from a correct reasoning path in the second set of candidate results changes corresponding to changes in the counterfactual context data.

In this way, change-of-thought machine-learning model debiasing techniques and systems as implemented by the debiasing module 122 are configurable to detect and even mitigate an effect of bias in an internal representation of a machine-learning model 124, such as a large language model 212. By changing a value of the context data (e.g., from factual to counterfactual), the debiasing module is configurable to estimate a causal effect between a chain-of-thought used by the machine-learning model to generate a result as an answer to a query. In this way, a correlation between one or more chains-of-thought used by the machine-learning model to generate the results is usable to detect the causal effect and thus potential bias in the internal knowledge representation of the machine-learning model. This detection is usable in a variety of ways, including detection of accuracy in generating the results, bias mitigation, and so forth.

### Example System and Device

FIG. 9 illustrates an example system generally at 900 that includes an example computing device 902 that is representative of one or more computing systems and/or devices that implement the various techniques described herein. This is illustrated through inclusion of the search system 120. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912 that stores instructions that are executable to cause the processing device 904 to perform operations. The computer-readable storage medium is configured for storing instructions that, responsive to execution by the processing device, causes the processing device to perform operations. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

In implementations, the platform 916 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a query;
producing, by the processing device, context data based on the query;
generating, by the processing device, a prompt including the context data, the query, and a chain-of-though prompt;
receiving, by the processing device, a candidate result based on processing of the prompt using a machine-learning model, the candidate result including a candidate answer and a chain-of-thought result describing reasoning indicated by the machine-learning model as used in generating the candidate answer; and
presenting, by the processing device, the candidate result including the candidate answer and the chain-of-thought result for output.

2. The method as described in claim 1, wherein the producing of the context data is performed from an external knowledge source independently of an internal knowledge source utilized by the machine-learning model.

3. The method as described in claim 1, further comprising estimating bias from the machine-learning model in generating the candidate result based on irrelevant information included in the context data.

4. The method as described in claim 1, wherein the generating includes generating:
a factual prompt including the query, the chain-of-thought prompt, and factual context data; and
a counterfactual prompt including the query, the chain-of-thought prompt, and counterfactual context data.

5. The method as described in claim 4, wherein the generating in the counterfactual prompt includes replacing an entity specified in the factual context data with another entity as the counterfactual context data.

6. The method as described in claim 4, further comprising estimating a causal effect of the context data based on a factual candidate result generated by the machine-learning model based on the factual prompt and a counterfactual candidate result generated by the machine-learning model based on the counterfactual prompt.

7. The method as described in claim 6, wherein the estimating is performed by comparing a factual candidate answer and a factual chain-of-though result of the factual candidate result with a counterfactual candidate answer and a counterfactual chain-of-though result of the counterfactual candidate result.

8. The method as described in claim 6, wherein the causal effect is an average causal effect.

9. The method as described in claim 1, wherein the machine-learning model is a large language model.

10. A computing device comprising:
a processing device; and
a computer-readable storage medium storing instructions that, responsive to execution by the processing device, causes the processing device to perform operations including:
generating a factual prompt including a query, a chain-of-thought prompt, and factual context data and a counterfactual prompt including the query, the chain-of-thought prompt, and counterfactual context data;
receiving a factual candidate result based on processing of the factual prompt using a machine-learning model;
receiving a counterfactual candidate result based on processing of the counterfactual context data using the machine-learning model; and
estimating bias in an internal knowledge source of the machine-learning model based on the factual candidate result and the counterfactual candidate result.

11. The computing device as described in claim 10, wherein the estimating is performed by comparing a factual candidate answer and a factual chain-of-though result of the factual candidate result with a counterfactual candidate answer and a counterfactual chain-of-though result of the counterfactual candidate result.

12. The computing device as described in claim 11, wherein:
the factual chain-of-thought result describes reasoning indicated by the machine-learning model as used in generating the factual candidate answer based on the factual prompt; and
the counterfactual chain-of-thought result describes reasoning indicated by the machine-learning model as used in generating the counterfactual candidate answer based on the counterfactual prompt.

13. The computing device as described in claim 10, wherein the generating of the counterfactual prompt includes replacing an entity specified in the factual context data with another entity as the counterfactual context data.

14. The computing device as described in claim 10, wherein the factual context data is located from an external knowledge source independent of an internal knowledge source utilized by the machine-learning model.

15. The computing device as described in claim 10, further comprising mediating subsequent operation of the machine-learning model based on the estimating.

16. A method comprising:
generating, by a processing device, a plurality of prompts respectively including a query, context data based on the query, and a chain-of-though prompt;
generating, by the processing device, a plurality of candidate results by processing the plurality of prompts using a machine-learning model, each said candidate result including a candidate answer and a chain-of-thought result describing reasoning indicated by the machine-learning model as used in generating the candidate answer;
estimating, by the processing device, a causal effect of the context data on operation of the machine-learning model based on the plurality of candidate results; and
mediating, by the processing device, subsequent operation of the machine-learning model based on the estimating.

17. The method as described in claim 16, wherein the plurality of prompts include:
a factual prompt including the query, the chain-of-thought prompt, and factual said context data; and
a counterfactual prompt including the query, the chain-of-thought prompt, and counterfactual said context data.

18. The method as described in claim 17, wherein the factual said context data is located from an external knowledge source independent of an internal knowledge source utilized by the machine-learning model.

19. The method as described in claim 18, wherein the causal effect indicates bias in the internal knowledge source of the machine-learning model.

20. The method as described in claim 17, wherein the counterfactual prompt is generated by replacing an entity specified in the factual said context data with another entity as the counterfactual said context data.
